(19) United States
(12) Patent Application Publication
(10) Pub. No.: US 2026/0003683 A1
(43) Pub. Date: Jan. 1, 2026

(54) DISTRIBUTED DATA COMPUTING SOLUTION

(71) Applicant: eBay Inc., San Jose, CA (US)

(72) Inventor: Wentao Liu, Mercer Island, WA (US)

(21) Appl. No.: 18/754,664

(22) Filed: Jun. 26, 2024

(51) Int. Cl. G06F 9/50

(52) U.S. Cl. CPC G06F 9/5027

(57) ABSTRACT

A triggering event is received. A paging entity and an action entity are identified based on a job description associated with the triggering event. Job data is retrieved from a data source based on the paging entity. The pagination engine is integrated with a plurality of data sources for job data retrieval. An action on the job data is performed based on the action entity. The action engine is integrated with a plurality of downstream components for action processing.

### TECHNICAL FIELD

The present disclosure generally relates to distributed data computing technologies. More particularly, various embodiments described herein provide for systems, methods, techniques, instruction sequences, and devices that facilitate the management and optimization of data processing across multiple data sources.

### BACKGROUND

In distributed computing environments, handling large-scale data operations involves complex processes of data retrieval and processing across multiple systems. These operations often require the execution of repetitive tasks, such as data querying and aggregation, which can burden system resources and complicate application development. Organizations face challenges in efficiently managing these tasks while ensuring that data remains consistent and accessible across different platforms. The increasing volume and velocity of data in modern computing landscapes further exacerbate these challenges, necessitating robust strategies for managing data workflows in a distributed setting.

### SUMMARY

A triggering event is received. The triggering event corresponds to a job description. A paging entity and an action entity are identified based on the job descriptions. A pagination engine is used to retrieve job data from a data source based on the paging entity. The pagination engine is integrated with a plurality of data sources for job data retrieval. An action engine is used to perform an action on the job data based on the action entity. The action engine is integrated with a plurality of downstream components for action processing.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system that includes a data management system, according to various embodiments of the present disclosure.

FIG. 2 is a block diagram illustrating an example data management system that facilitates the management and optimization of data processing across multiple data sources, according to various embodiments of the present disclosure.

FIG. 3 is a flowchart illustrating an example method for facilitating the management and optimization of data processing across multiple data sources, according to various embodiments of the present disclosure.

FIG. 4 is a flowchart illustrating an example method for facilitating the management and optimization of data processing across multiple data sources, according to various embodiments of the present disclosure.

FIGS. 5 and 6 are a diagram illustrating an example fanout system that facilitates the management and optimization of data processing across multiple data sources, according to various embodiments of the present disclosure.

FIG. 7 is a block diagram illustrating a representative software architecture, which may be used in conjunction with various hardware architectures herein described, according to various embodiments of the present disclosure.

FIG. 8 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various embodiments may be given throughout this description. These are merely descriptions of specific embodiments. The scope or meaning of the claims is not limited to the embodiments given.

Various embodiments include systems, methods, and non-transitory computer-readable media that facilitate the management and optimization of data processing across multiple data sources, according to various embodiments of the present disclosure. Specifically, various embodiments include a fanout system, which addresses challenges in distributed data computing. This fanout system is designed to streamline the process of querying and processing a large volume of data retrieved from various sources upon specific triggers. The fanout computing mechanism involves triggering, upon receiving requests or detecting triggering events, the fanout system to query one or more integrated data sources (e.g., databases, services, distributed computing frameworks) and process a large volume of queried data in response to the requests or triggering events.

The fanout system allows clients, which can be either human operators, or automated systems, or applications, to define specific conditions under which a fanout should be triggered. This includes specifying the data sources from which data should be read and the targets where the results of the data reading should be notified. By doing so, the platform automates the triggering and data handling processes, which traditionally require manual intervention and repetitive coding.

Components of the fanout system include a trigger engine, a pagination engine, an action engine, and an orchestration engine. The trigger engine is responsible for initiating the fanout process based on predefined conditions configured by the client. This could involve detecting (or listening for) specific events or changes in data that meet the client's criteria. Once triggered, the pagination engine retrieves the necessary data from the specified sources. This engine is integrated with multiple data sources, enabling it to pull data efficiently across different environments.

The action engine processes the retrieved data according to the client's specifications. This might involve filtering, sorting, or applying business logic to the data. The processed data is then passed to downstream components, which could be other applications or systems that need this data for further processing or for generating insights.

The orchestration engine coordinates the interactions between the trigger engine, pagination engine, and action engine. It ensures that the data flows smoothly from one component to the next and that the operations are performed in the correct sequence. This coordination is crucial for maintaining the efficiency and reliability of the system, especially when handling large volumes of data.

The fanout system is designed to be generic and reusable. Unlike traditional systems where each new application may need to develop its own mechanisms for data handling, the fanout system provides a standardized way to manage these operations. This reduces the development effort required when building new applications and allows for greater consistency across different projects.

In addition, by automating the data handling processes, the fanout system reduces the need for manual coding and intervention. This not only speeds up the development process but also minimizes the chances of errors that can occur with manual processes. Additionally, the system's ability to integrate with multiple data sources and downstream components makes it highly adaptable to various business needs.

The fanout system also addresses issues related to maintenance and flexibility that are common in traditional systems. By providing a standardized and centralized way to manage data handling, it simplifies the maintenance of the system. Changes to the data handling logic or to the data sources can be managed centrally within the platform, without needing to alter individual applications.

In general, the fanout system provides a comprehensive solution for managing distributed data computing tasks. By automating and standardizing the processes of triggering, data retrieval, and data processing, the system enhances the efficiency and reliability of data handling in distributed computing environments. Although the fanout system may be applicable in many contexts, the fanout system is particularly useful for organizations that deal with large volumes of data and require robust systems to manage data workflows efficiently.

In various embodiments, the fanout system receives one or more triggering events. A triggering event can be received via an Application Programming Interface (API), a messaging system, or via a user interface. A triggering event can correspond to a job description. In various embodiments, the fanout system can identify the job description based on the triggering event. The fanout system identifies a paging entity and an action entity based on the job description. In various embodiments, a job description at least includes a paging entity, an action entity. A paging entity specifies job data and one or more data sources (e.g., databases, services, distributed computing frameworks) from which the job data can be retrieved. An action entity specifies the action and a downstream component associated with the action. A downstream component can be an application or a system that needs the processed data for further processing or for generating insights.

In various embodiments, the fanout system uses the pagination engine to retrieve job data from a data source based on the paging entity. The pagination engine is integrated with a plurality of data sources for job data retrieval. The fanout system uses the action engine to perform one or more actions on the job data based on the action entity. The action engine is integrated with a plurality of downstream components for action processing.

In various embodiments, the plurality of data sources comprises one or more of a plurality of databases, a plurality of services, and a plurality of distributed computing frameworks that enable distributed processing of large datasets across clusters of computing hardware.

In various embodiments, the pagination engine communicates with the plurality of data sources using an Application Programming Interface (API), Structured query language (SQL), or Domain-specific language (DSL). The paging entity includes one or more of an endpoint, a parameter, a data source type, and a path. A parameter can describe the job data to be retrieved using the pagination engine. For example, a parameter can include a name (“base_query_statement_name”) and a value (“find By Seller Id Listing Site”). In this particular example, the job data includes all seller identifiers from the “Listing Site.” In various embodiments, the action entity can include one or more of an endpoint and a downstream component type. An endpoint can describe an action, such as sending a message to all the sellers associated with the retrieved seller identifiers. The downstream component type can correspond to a downstream component (e.g., message queue) to which the action is to be performed.

In various embodiments, in response to receiving the triggering event, the fanout system identifies the paging entity and the action entity using a trigger engine. The trigger engine is integrated with one or more clients (e.g., one or more human operators, one or more applications) that generate a plurality of triggering events. Users are used interchangeably with human operators, as described herein.

In various embodiments, the fanout system uses an orchestration engine to coordinate communication between the trigger engine, the pagination engine, and the action engine.

In various embodiments, the fanout system identifies the job description based on the triggering event. In response to identifying the job description, the fanout system generates a job instance based on the job description. A job instance refers to a concrete instance of a specific task or a job defined by criteria outlined in a job description. In various embodiments, job instances can be dynamically generated based on changing conditions or requirements. By modifying the underlying job descriptions, organizations can adapt their workflows to evolving business needs without significant reconfiguration.

In various embodiments, the fanout system executes the job instance. The execution of the job instance can include using the action engine to perform the action on the job data retrieved by the pagination engine, as described herein. The advantage of the approach is the automation and efficient handling of tasks based on triggering events. By identifying the job description and generating a corresponding job instance automatically, the fanout system streamlines the execution of tasks without manual intervention. Additionally, by utilizing an action engine to perform actions on job data retrieved by the pagination engine, the system ensures a seamless and optimized workflow, enhancing productivity and reducing the potential for errors.

Reference will now be made in detail to embodiments of the present disclosure, examples of which are illustrated in the appended drawings. The present disclosure may, however, be embodied in many different forms and should not be construed as being limited to the embodiments set forth herein.

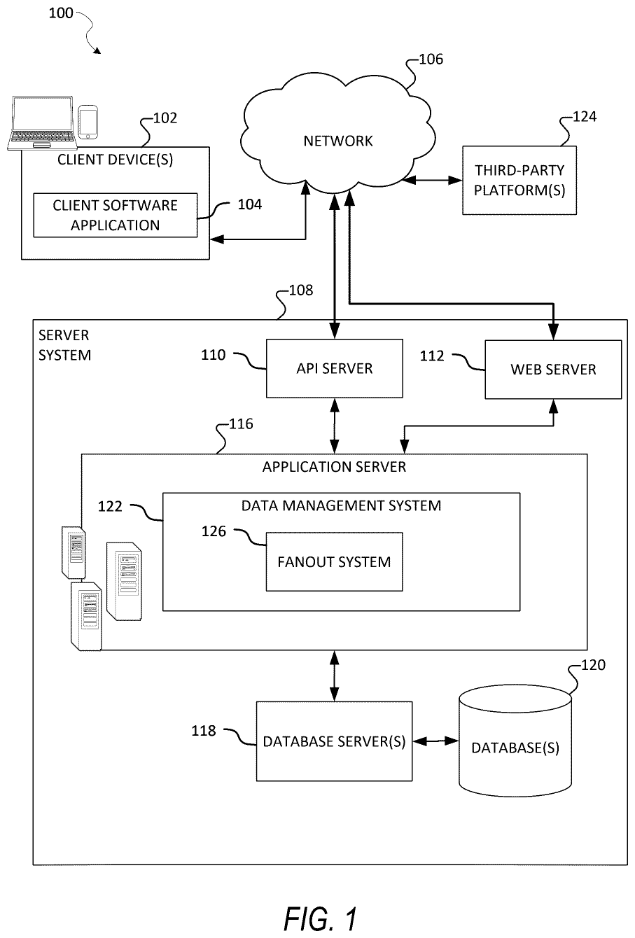

FIG. 1 is a block diagram showing an example data system 100 that includes a fanout system 126 (also referred to as system 126), according to various embodiments of the present disclosure. By including the fanout system 126, the data system 100 can facilitate the management and optimization of data processing across multiple data sources. As shown, the data system 100 includes one or more client devices 102, a server system 108, and a network 106 (e.g., Internet, wide-area-network (WAN), local-area-network (LAN), wireless network) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the data management system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

As illustrated in FIG. 1, the data management system 122 includes the fanout system 126. In various embodiments, the data management system 122 can include one or more components of the fanout system 126.

The server system 108 supports various services and operations that are provided to the client software application 104 by the data management system 122. Such operations include transmitting data from the data management system 122 to the client software application 104, receiving data from the client software application 104 at the data management system 122, and the data management system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, an Application Program Interface (API) server 110 and a web server 112 is coupled to an application server 116, which hosts the data management system 122. The application server 116 is communicatively coupled to a database server 118, which facilitates access to a database 120 that stores data associated with the application server 116, including data that may be generated or used by the data management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation, user registration; login functionality; data object operations (e.g., generating, storing, retrieving, encrypting, decrypting, transferring, access rights, licensing); and/or user communications.

The server system 108, or the data management system 122 may extract user data from one or more third-party platforms (e.g., third-party social media platforms). The extracted data may be open-source poster data associated with targeted influencers on the one or more third-party platforms 124 and may include user profile data, activity data, and media posted (either created and/or shared) by the one or more influencers. The media (or media data) include text, image, video, audio, and metadata. Example metadata may include hashtags and labels.

Through one or more web-based interfaces (e.g., web-based user interfaces), the web server 112 can support various functionality of the data management system 122 of the application server 116.

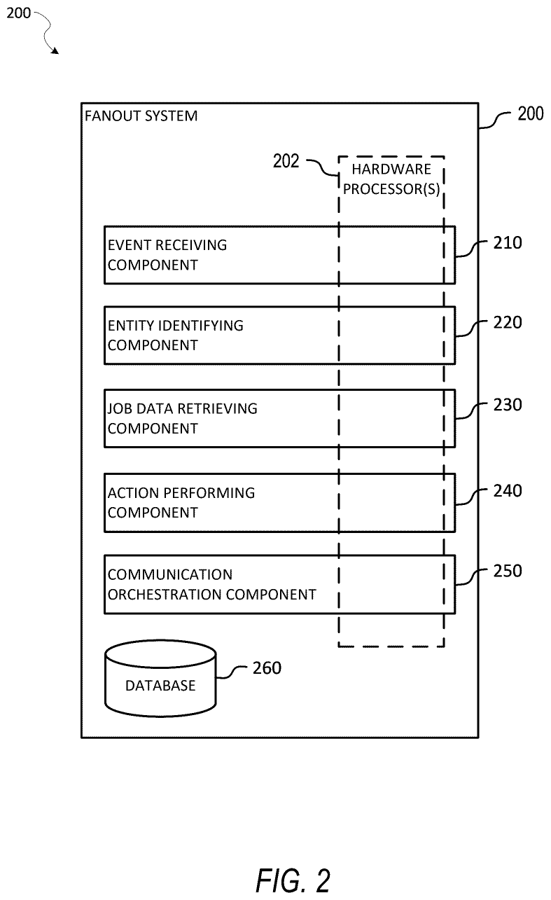

FIG. 2 is a block diagram illustrating an example fanout system 200 that facilitates the management and optimization of data processing across multiple data sources, according to various embodiments of the present disclosure. For some embodiments, the fanout system 200 represents an example of the fanout system 126 described with respect to FIG. 1. As shown, the fanout system 200 comprises an event receiving component 210, an entity identifying component 220, a job data retrieving component 230, an action performing component 240, and a communication orchestration component 250. According to various embodiments, one or more of the event receiving component 210, the entity identifying component 220, the job data retrieving component 230, the action performing component 240, and the communication orchestration component 250 are implemented by one or more hardware processors 202. Data generated by one or more of the event receiving component 210, the entity identifying component 220, the job data retrieving component 230, the action performing component 240, and the communication orchestration component 250 may be stored in a database (or datastore) 260 of the fanout system 200.

The event receiving component 210 is configured to receive one or more triggering events. The one or more triggering events can be received via an Application Programming Interface (API) or a user interface.

The entity identifying component 220 is configured to identify a paging entity and an action entity based on the job description. A paging entity specifies job data and one or more data sources (e.g., databases, services, distributed computing frameworks) from which the job data can be retrieved. An action entity specifies the action and a downstream component associated with the action. A downstream component can be an application or a system that needs the processed data for further processing or for generating insights.

The job data retrieving component 230 is configured to use the pagination engine to retrieve job data from a data source based on the paging entity. The pagination engine is integrated with a plurality of data sources for job data retrieval. In various embodiments, the pagination engine communicates with the plurality of data sources using Structured query language (SQL).

The action performing component 240 is configured to use the action engine to perform one or more actions on the job data based on the action entity. The action engine is integrated with a plurality of downstream components for action processing. The action processing can include filtering, sorting, or applying business logic to the data, depending on the tasks specified in the action entity. The processed data is then passed to downstream components, which could be other applications or systems that need this data for further processing or for generating insights.

The communication orchestration component 250 is configured to use an orchestration engine to coordinate communication between the trigger engine, the pagination engine, and the action engine.

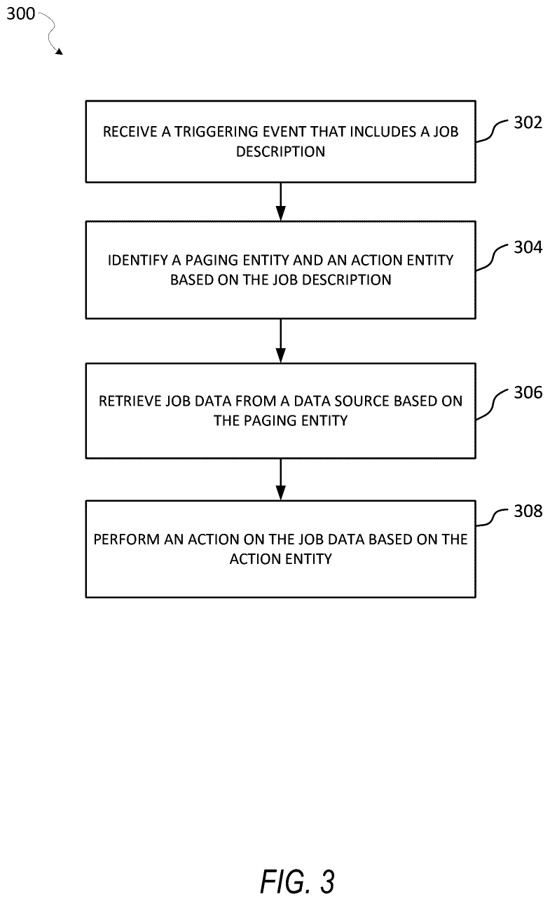

FIG. 3 is a flowchart illustrating an example method 300 for facilitating the management and optimization of data processing across multiple data sources, according to various embodiments of the present disclosure. It will be understood that example methods described herein may be performed by a machine in accordance with some embodiments. For example, method 300 can be performed by the fanout system 126 described with respect to FIG. 1, the fanout system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform method 300. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 302, a processor receives one or more triggering events. Triggering events can be received via an Application Programming Interface (API) or a user interface.

At operation 304, a processor identifies a paging entity and an action entity based on the job description. A paging entity specifies job data and one or more data sources (e.g., databases, services, distributed computing frameworks) from which the job data can be retrieved. An action entity specifies the action and a downstream component associated with the action. A downstream component can be an application or a system that needs the processed data for further processing or for generating insights.

At operation 306, a processor uses the pagination engine to retrieve job data from a data source based on the paging entity. The pagination engine is integrated with a plurality of data sources for job data retrieval. In various embodiments, the pagination engine communicates with the plurality of data sources using Structured query language (SQL).

At operation 308, a processor uses the action engine to perform one or more actions on the job data based on the action entity. The action engine is integrated with a plurality of downstream components for action processing. The action processing can include filtering, sorting, or applying business logic to the data, depending on the tasks specified in the action entity. The processed data is then passed to downstream components, which could be other applications or systems that need this data for further processing or for generating insights.

Though not illustrated, method 300 can include an operation where a graphical user interface is displayed (or caused to be displayed) by the hardware processor. For instance, the operation can cause a client device (e.g., the client device 102 communicatively coupled to the fanout system 126) to display the graphical user interface. This operation for displaying the graphical user interface can be separate from operations 302 through 308 or, alternatively, form part of one or more of operations 302 through 308.

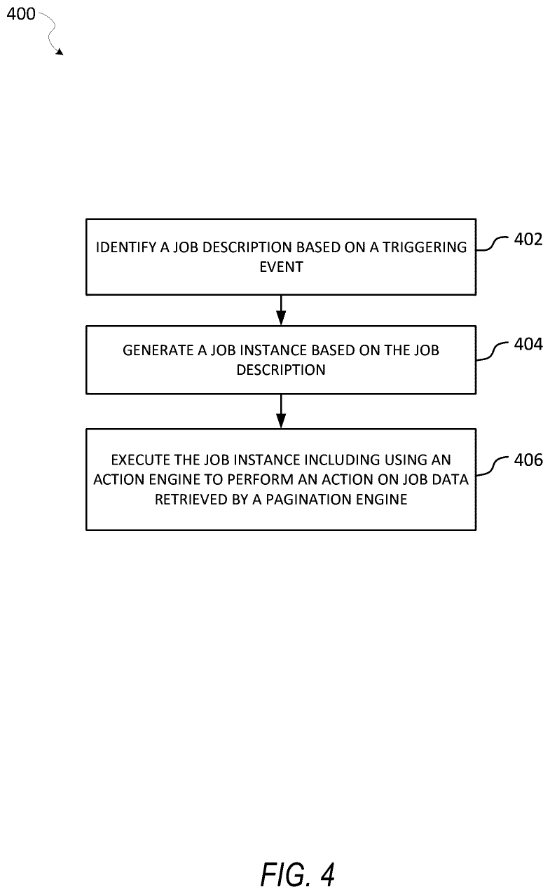

FIG. 4 is a flowchart illustrating an example method 400 for facilitating the management and optimization of data processing across multiple data sources, according to various embodiments of the present disclosure. It will be understood that example methods described herein may be performed by a machine in accordance with some embodiments. For example, method 400 can be performed by the fanout system 126 described with respect to FIG. 1, the fanout system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 400 can be performed dependently or independently from operations in method 300.

At operation 402, a processor identifies a job description based on a triggering event.

At operation 404, a processor, in response to identifying the job description, generates a job instance based on the job description. A job instance represents a specific instantiation of a task or job defined by criteria outlined in a job description. In various embodiments, job instances can be dynamically generated based on changing conditions or requirements. By modifying the underlying job descriptions, organizations can adapt their workflows to evolving business needs without significant reconfiguration.

At operation 406, a processor executes the job instance. The execution of the job instance can include using the action engine to perform the action on the job data retrieved by the pagination engine, as described herein. The advantage of the fanout computing mechanism is the automation and efficient handling of tasks based on triggering events. By identifying the job description and generating a corresponding job instance automatically, the fanout system streamlines the execution of tasks without manual intervention. Additionally, by utilizing an action engine to perform actions on job data retrieved by the pagination engine, the system ensures a seamless and optimized workflow, enhancing productivity and reducing the potential for errors.

Though not illustrated, method 400 can include an operation where a graphical user interface can be displayed (or caused to be displayed) by the hardware processor. For instance, the operation can cause a client device (e.g., the client device 102 communicatively coupled to the fanout system 126) to display the graphical user interface. This operation for displaying the graphical user interface can be separate from operations 402 through 406 or, alternatively, form part of one or more of operations 402 through 406.

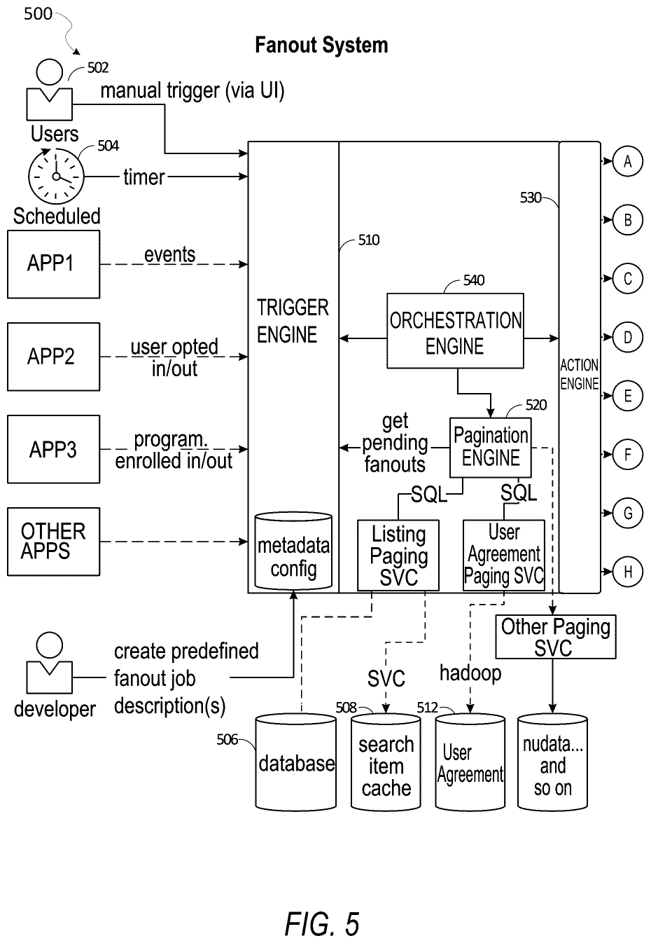

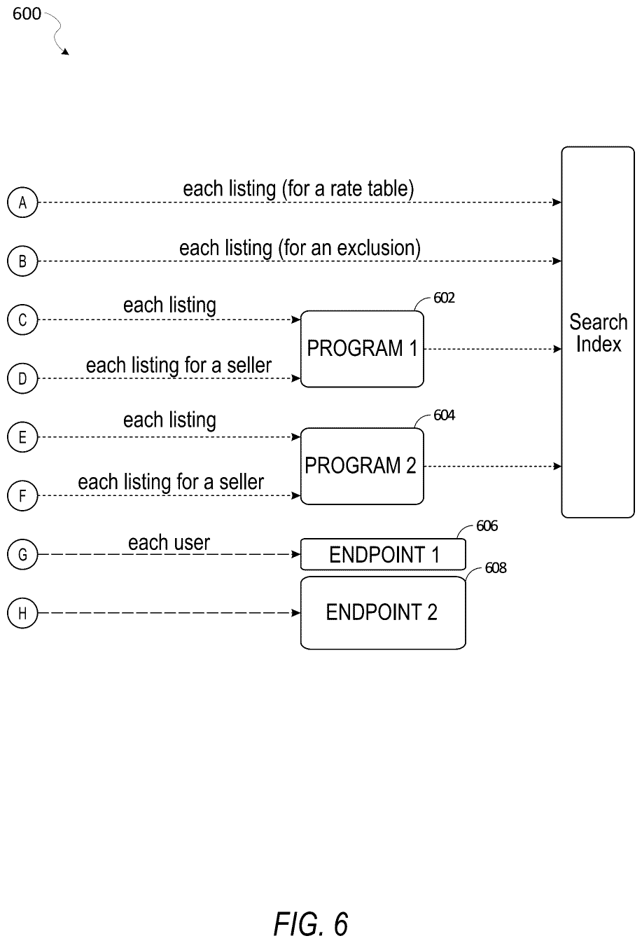

FIGS. 5 and 6 are a diagram illustrating an example fanout system that facilitates the management and optimization of data processing across multiple data sources, according to various embodiments of the present disclosure. As shown, the example fanout system includes a trigger engine 510, a pagination engine 520, an action engine 530, and an orchestration engine 540. Triggering events can be generated by a user 502, a timer 504, and various applications (e.g., APP1, APP2, APP3). The pagination engine 520 is integrated with a plurality of data sources for job data retrieval. Data sources can include one or more databases (e.g., databases 506 and 508), and one or more computing frameworks (e.g., open-source framework 512). As shown, the action engine 530 is integrated with a plurality of downstream components for action processing. Downstream components can include various programs (e.g., programs 602 and 604) and endpoints (e.g., endpoints 606 and 608).

The integration of data sources and downstream components within the system is flexibly executed to align with diverse business requirements and is subject to dynamic updates. By automating the data handling processes, it reduces the need for manual coding and intervention. This not only speeds up the development process but also minimizes the chances of errors that can occur with manual processes. Additionally, the system's ability to integrate with multiple data sources and downstream components makes it highly adaptable to various business needs.

Example 1 is a system comprising: one or more hardware processors; and at least one machine-storage medium for storing instructions that, when executed by the one or more hardware processors, cause the one or more hardware processors to perform operations comprising: receiving, via an Application Programming Interface (API), a triggering event, the triggering event corresponding to a job description; identifying a paging entity and an action entity based on the job description; retrieving, using a pagination engine, job data from a data source based on the paging entity, the pagination engine being integrated with a plurality of data sources for job data retrieval; and performing, using an action engine, an action on the job data based on the action entity, the action engine being integrated with a plurality of downstream components for action processing.

In Example 2, the subject matter of Example 1 includes, wherein the operations comprise: identifying the job description based on the triggering event; in response to identifying the job description, generating a job instance based on the job description; and executing the job instance, the executing of the job instance including using the action engine to perform the action on the job data retrieved by the pagination engine.

In Example 3, the subject matter of Examples 1-2 includes, wherein the paging entity specifies the job data and the data source from the plurality of data sources where the job data is retrieved, and wherein the action entity specifies the action and a downstream component associated with the action.

In Example 4, the subject matter of Examples 1-3 includes, wherein the plurality of data sources comprises one or more of a plurality of databases, a plurality of services, and a plurality of distributed computing frameworks that enable distributed processing of large datasets across clusters of computing hardware.

In Example 5, the subject matter of Examples 1-4 includes, wherein the pagination engine communicates with the plurality of data sources using one of Application Programming Interface (API), Structured query language (SQL), or Domain-specific Language (DSL).

In Example 6, the subject matter of Examples 1-5 includes, wherein the operations comprise: in response to receiving the triggering event, identifying the paging entity and the action entity using a trigger engine, the trigger engine being integrated with one or more users and one or more applications that generate a plurality of triggering events.

In Example 7, the subject matter of Example 6 includes, wherein the operations comprise: coordinating, using an orchestration engine, communication between the trigger engine, the pagination engine, and the action engine.

In Example 8, the subject matter of Examples 1-7 includes, wherein the paging entity comprises one or more of an endpoint, a parameter, a data source type, and a path.

In Example 9, the subject matter of Example 8 includes, wherein the parameter describes the job data to be retrieved using the pagination engine.

In Example 10, the subject matter of Examples 1-9 includes, wherein the action entity comprises one or more of an endpoint and a downstream component type, wherein the endpoint describes an action, and wherein the downstream component type corresponds to a message queue to which the action is to be performed.

Example 11 is a method comprising: receiving, via an Application Programming Interface (API), a triggering event, the triggering event corresponding to a job description; identifying a paging entity and an action entity based on the job description; retrieving, using a pagination engine, job data from a data source based on the paging entity, the pagination engine being integrated with a plurality of data sources for job data retrieval; and performing, using an action engine, an action on the job data based on the action entity, the action engine being integrated with a plurality of downstream components for action processing.

In Example 12, the subject matter of Example 11 includes, identifying the job description based on the triggering event; in response to identifying the job description, generating a job instance based on the job description; and executing the job instance, the executing of the job instance including using the action engine to perform the action on the job data retrieved by the pagination engine.

In Example 13, the subject matter of Examples 11-12 includes, wherein the paging entity specifies the job data and the data source from the plurality of data sources where the job data is retrieved, and wherein the action entity specifies the action and a downstream component associated with the action.

In Example 14, the subject matter of Examples 11-13 includes, wherein the plurality of data sources comprises one or more of a plurality of databases, a plurality of services, and a plurality of distributed computing frameworks that enable distributed processing of large datasets across clusters of computing hardware.

In Example 15, the subject matter of Examples 11-14 includes, wherein the pagination engine communicates with the plurality of data sources using one of Application Programming Interface (API), Structured query language (SQL), or Domain-specific Language (DSL).

In Example 16, the subject matter of Examples 11-15 includes, in response to receiving the triggering event, identifying the paging entity and the action entity using a trigger engine, the trigger engine being integrated with one or more users and one or more applications that generate a plurality of triggering events.

In Example 17, the subject matter of Example 16 includes, coordinating, using an orchestration engine, communication between the trigger engine, the pagination engine, and the action engine.

In Example 18, the subject matter of Examples 11-17 includes, wherein the paging entity comprises one or more of an endpoint, a parameter, a data source type, and a path, and wherein the parameter describes the job data to be retrieved using the pagination engine.

In Example 19, the subject matter of Examples 11-18 includes, wherein the action entity comprises one or more of an endpoint and a downstream component type, wherein the endpoint describes an action, and wherein the downstream component type corresponds to a message queue to which the action is to be performed.

Example 20 is a machine-storage medium for storing instructions that, when executed by one or more hardware processors, cause the one or more hardware processors to perform operations comprising: receiving, via an Application Programming Interface (API), a triggering event, the triggering event corresponding to a job description; identifying a paging entity and an action entity based on the job description; retrieving, using a pagination engine, job data from a data source based on the paging entity, the pagination engine being integrated with a plurality of data sources for job data retrieval; and performing, using an action engine, an action on the job data based on the action entity, the action engine being integrated with a plurality of downstream components for action processing.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

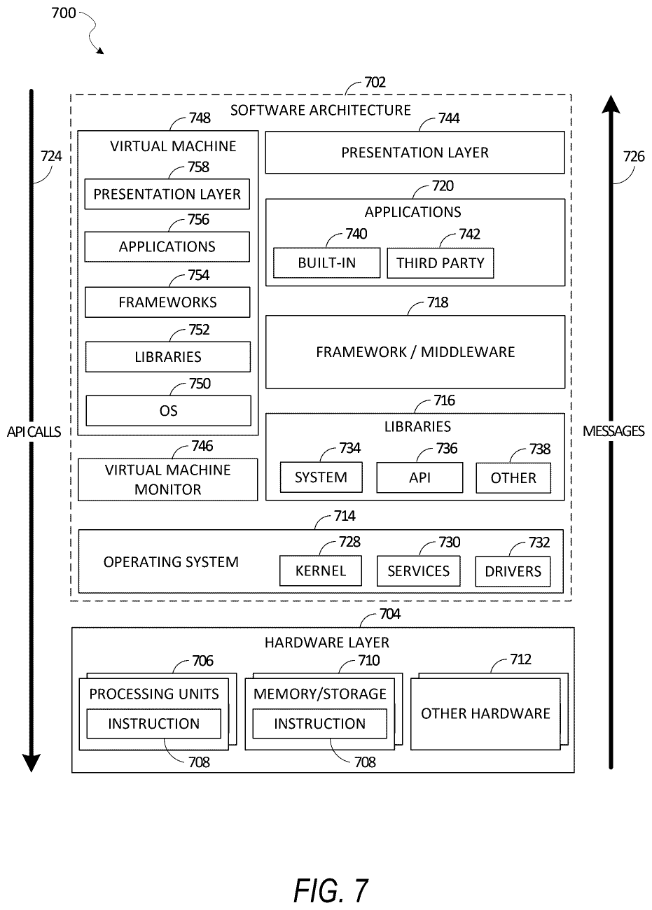

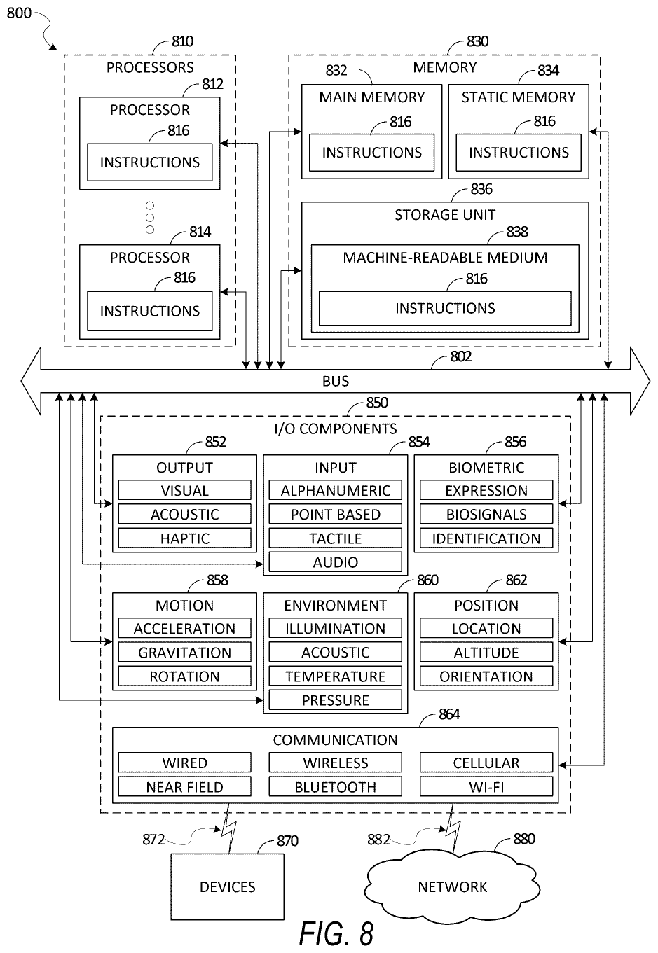

FIG. 7 is a block diagram illustrating an example of a software architecture 702 that may be installed on a machine, according to some example embodiments. FIG. 7 is merely a non-limiting example of a software architecture, and it will be appreciated that many other architectures may be implemented to facilitate the functionality described herein. The software architecture 702 may be executing on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 comprises one or more processing units 706 having associated executable instructions 708. The executable instructions 708 represent the executable instructions of the software architecture 702. The hardware layer 704 also includes memory or storage modules (storage components) 710, which also have the executable instructions 708. The hardware layer 704 may also comprise other hardware 712, which represents any other hardware of the hardware layer 704, such as the other hardware illustrated as part of the machine 800.

In the example architecture of FIG. 7, the software architecture 702 may be conceptualized as a stack of layers, where each layer provides particular functionality. For example, the software architecture 702 may include layers such as an operating system 714, libraries 716, frameworks/middleware 718, applications 720, and a presentation layer 744. Operationally, the applications 720 or other components within the layers may invoke API calls 724 through the software stack and receive a response, returned values, and so forth (illustrated as messages 726) in response to the API calls 724. The layers illustrated are representative in nature, and not all software architectures have all layers. For example, some mobile or special-purpose operating systems may not provide a frameworks/middleware 718 layer, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software components/modules to perform tasks in an easier fashion than by interfacing directly with the underlying operating system 714 functionality (e.g., kernel 728, services 730, or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred to as middleware) may provide a higher-level common infrastructure that may be utilized by the applications 720 or other software components/modules. For example, the frameworks 718 may provide various graphical user interface functions, high-level resource management, high-level location services, and so forth. The frameworks 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a home application, a contacts application, a browser application, a book reader application, a location application, a media application, a messaging application, or a game application.

The third-party applications 742 may include any of the built-in applications 740, as well as a broad assortment of other applications. In a specific example, the third-party applications 742 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 742 may invoke the API calls 724 provided by the mobile operating system such as the operating system 714 to facilitate functionality described herein.

The applications 720 may utilize built-in operating system functions (e.g., kernel 728, services 730, or drivers 732), libraries (e.g., system libraries 734, API libraries 736, and other libraries 738), or frameworks/middleware 718 to create user interfaces to interact with users of the system. Alternatively, or additionally, in some systems, interactions with a user may occur through a presentation layer, such as the presentation layer 744. In these systems, the application/module “logic” can be separated from the aspects of the application/module that interact with the user.

Some software architectures utilize virtual machines. In the example of FIG. 7, this is illustrated by a virtual machine 748. The virtual machine 748 creates a software environment where applications/modules can execute as if they were executing on a hardware machine (e.g., the machine 800 of FIG. 8). The virtual machine 748 is hosted by a host operating system (e.g., the operating system 714) and typically, although not always, has a virtual machine monitor 746, which manages the operation of the virtual machine 748 as well as the interface with the host operating system (e.g., the operating system 714). A software architecture executes within the virtual machine 748, such as an operating system 750, libraries 752, frameworks 754, applications 756, or a presentation layer 758. These layers of software architecture executing within the virtual machine 748 can be the same as corresponding layers previously described or may be different.

FIG. 8 illustrates a diagrammatic representation of a machine 800 in the form of a computer system within which a set of instructions may be executed for causing the machine 800 to perform any one or more of the methodologies discussed herein, according to an embodiment. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute the method 300 described above with respect to FIG. 3, and the method 400 described above with respect to FIG. 4. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an embodiment, the processors 810 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors that may comprise two or more independent processors (sometimes referred to as “cores”) that may execute instructions contemporaneously. Although FIG. 8 shows multiple processors 810, the machine 800 may include a single processor with a single core, a single processor with multiple cores (e.g., a multi-core processor), multiple processors with a single core, multiple processors with multiples cores, or any combination thereof.

The memory 830 may include a main memory 832, a static memory 834, and a storage unit 836 including machine-readable medium 838, each accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In some examples, the I/O components 850 may include output components 852 and input components 854. The output components 852 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 850 may include biometric components 856, motion components 858, environmental components 860, or position components 862, among a wide array of other components. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

Certain embodiments are described herein as including logic or a number of components, components, elements, or mechanisms. Such components can constitute either software components (e.g., code embodied on a machine-readable medium or in a transmission signal) or hardware components. A “hardware component” is a tangible unit capable of performing certain operations and can be configured or arranged in a certain physical manner. In various example embodiments, one or more computer systems (e.g., a standalone computer system, a client computer system, or a server computer system) or one or more hardware components of a computer system (e.g., a processor or a group of processors) are configured by software (e.g., an application or application portion) as a hardware component that operates to perform certain operations as described herein.

In some examples, a hardware component is implemented mechanically, electronically, or any suitable combination thereof. For example, a hardware component can include dedicated circuitry or logic that is permanently configured to perform certain operations. For example, a hardware component can be a special-purpose processor, such as a field-programmable gate array (FPGA) or an ASIC. A hardware component may also include programmable logic or circuitry that is temporarily configured by software to perform certain operations. For example, a hardware component can include software encompassed within a general-purpose processor or other programmable processor. It will be appreciated that the decision to implement a hardware component mechanically, in dedicated and permanently configured circuitry, or in temporarily configured circuitry (e.g., configured by software) can be driven by cost and time considerations.

Accordingly, the phrase “component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software can accordingly configure a particular processor or processors, for example, to constitute a particular hardware component at one instance of time and to constitute a different hardware component at a different instance of time.

Hardware components can provide information to, and receive information from, other hardware components. Accordingly, the described hardware components can be regarded as being communicatively coupled. Where multiple hardware components exist contemporaneously, communications can be achieved through signal transmission (e.g., over appropriate circuits and buses) between or among two or more of the hardware components. In embodiments in which multiple hardware components are configured or instantiated at different times, communications between or among such hardware components may be achieved, for example, through the storage and retrieval of information in memory structures to which the multiple hardware components have access. For example, one hardware component performs an operation and stores the output of that operation in a memory device to which it is communicatively coupled. A further hardware component can then, at a later time, access the memory device to retrieve and process the stored output. Hardware components can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented components that operate to perform one or more operations or functions described herein. As used herein, “processor-implemented component” refers to a hardware component implemented using one or more processors.

Similarly, the methods described herein can be at least partially processor-implemented, with a particular processor or processors being an example of hardware. For example, at least some of the operations of a method can be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines 800 including processors 810), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 800, but deployed across a number of machines 800. In some example embodiments, the processors 810 or processor-implemented components are located in a single geographic location (e.g., within a home environment, an office environment, or a server farm). In other example embodiments, the processors or processor-implemented components are distributed across a number of geographic locations.

The various memories (i.e., 830, 832, 834, and/or the memory of the processor(s) 810) and/or the storage unit 836 may store one or more sets of instructions 816 and data structures (e.g., software) embodying or utilized by any one or more of the methodologies or functions described herein. These instructions (e.g., the instructions 816), when executed by the processor(s) 810, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 816 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In some examples, one or more portions of the network 880 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, components, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system comprising:
one or more hardware processors; and
at least one machine-storage medium for storing instructions that, when executed by the one or more hardware processors, cause the one or more hardware processors to perform operations comprising:
receiving, via an Application Programming Interface (API), a triggering event, the triggering event corresponding to a job description;
identifying a paging entity and an action entity based on the job description;
retrieving, using a pagination engine, job data from a data source based on the paging entity, the pagination engine being integrated with a plurality of data sources for job data retrieval; and
performing, using an action engine, an action on the job data based on the action entity, the action engine being integrated with a plurality of downstream components for action processing.

2. The system of claim 1, wherein the operations comprise:
identifying the job description based on the triggering event;
in response to identifying the job description, generating a job instance based on the job description; and
executing the job instance, the executing of the job instance including using the action engine to perform the action on the job data retrieved by the pagination engine.

3. The system of claim 1, wherein the paging entity specifies the job data and the data source from the plurality of data sources where the job data is retrieved, and wherein the action entity specifies the action and a downstream component associated with the action.

4. The system of claim 1, wherein the plurality of data sources comprises one or more of a plurality of databases, a plurality of services, and a plurality of distributed computing frameworks that enable distributed processing of large datasets across clusters of computing hardware.

5. The system of claim 1, wherein the pagination engine communicates with the plurality of data sources using one of Application Programming Interface (API), Structured query language (SQL), or Domain-specific Language (DSL).

6. The system of claim 1, wherein the operations comprise:
in response to receiving the triggering event, identifying the paging entity and the action entity using a trigger engine, the trigger engine being integrated with one or more users and one or more applications that generate a plurality of triggering events.

7. The system of claim 6, wherein the operations comprise:
coordinating, using an orchestration engine, communication between the trigger engine, the pagination engine, and the action engine.

8. The system of claim 1, wherein the paging entity comprises one or more of an endpoint, a parameter, a data source type, and a path.

9. The system of claim 8, wherein the parameter describes the job data to be retrieved using the pagination engine.

10. The system of claim 1, wherein the action entity comprises one or more of an endpoint and a downstream component type, wherein the endpoint describes an action, and wherein the downstream component type corresponds to a message queue to which the action is to be performed.

11. A method comprising:
receiving, via an Application Programming Interface (API), a triggering event, the triggering event corresponding to a job description;
identifying a paging entity and an action entity based on the job description;
retrieving, using a pagination engine, job data from a data source based on the paging entity, the pagination engine being integrated with a plurality of data sources for job data retrieval; and
performing, using an action engine, an action on the job data based on the action entity, the action engine being integrated with a plurality of downstream components for action processing.

12. The method of claim 11, comprising:
identifying the job description based on the triggering event;
in response to identifying the job description, generating a job instance based on the job description; and
executing the job instance, the executing of the job instance including using the action engine to perform the action on the job data retrieved by the pagination engine.

13. The method of claim 11, wherein the paging entity specifies the job data and the data source from the plurality of data sources where the job data is retrieved, and wherein the action entity specifies the action and a downstream component associated with the action.

14. The method of claim 11, wherein the plurality of data sources comprises one or more of a plurality of databases, a plurality of services, and a plurality of distributed computing frameworks that enable distributed processing of large datasets across clusters of computing hardware.

15. The method of claim 11, wherein the pagination engine communicates with the plurality of data sources using one of Application Programming Interface (API), Structured query language (SQL), or Domain-specific Language (DSL).

16. The method of claim 11, comprising:
in response to receiving the triggering event, identifying the paging entity and the action entity using a trigger engine, the trigger engine being integrated with one or more users and one or more applications that generate a plurality of triggering events.

17. The method of claim 16, comprising:
coordinating, using an orchestration engine, communication between the trigger engine, the pagination engine, and the action engine.

18. The method of claim 11, wherein the paging entity comprises one or more of an endpoint, a parameter, a data source type, and a path, and wherein the parameter describes the job data to be retrieved using the pagination engine.

19. The method of claim 11, wherein the action entity comprises one or more of an endpoint and a downstream component type, wherein the endpoint describes an action, and wherein the downstream component type corresponds to a message queue to which the action is to be performed.

20. A machine-storage medium for storing instructions that, when executed by one or more hardware processors, cause the one or more hardware processors to perform operations comprising:
receiving, via an Application Programming Interface (API), a triggering event, the triggering event corresponding to a job description;
identifying a paging entity and an action entity based on the job description;
retrieving, using a pagination engine, job data from a data source based on the paging entity, the pagination engine being integrated with a plurality of data sources for job data retrieval; and
performing, using an action engine, an action on the job data based on the action entity, the action engine being integrated with a plurality of downstream components for action processing.
